(19) United States
(12) Patent Application Publication
(10) Pub. No.: US 2026/0336992 A1
(43) Pub. Date: Oct. 29, 2026

(54) AMR-BASED ADAPTIVE FORKING MECHANICAL STRUCTURE AND GRID-SHAPED PALLET HANDLING ROBOT

(71) Applicant: SUZHOU AITEN INTELLIGENT TECHNOLOGY CO., LTD., Suzhou (CN)

(72) Inventor: Haijin YAO, Suzhou (CN)

(21) Appl. No.: 19/362,576

(22) Filed: Oct. 20, 2025

Related U.S. Application Data
(63) Continuation of application No. PCT/CN2025/112591, filed on Aug. 5, 2025.

(30) Foreign Application Priority Data
Apr. 29, 2025 (CN) 202510549529.7

(51) Int. Cl. B66F 9/06; B66F 7/06; B66F 9/065; B66F 9/12

(52) U.S. Cl. CPC B66F 9/063; B66F 7/065; B66F 9/065; B66F 9/122

(57) ABSTRACT

An AMR-based adaptive forking mechanical structure includes a plate body mounted with a translation device, the translation device is mounted with a fork, the fork is mounted with a lifting device, which includes a mounting housing, the mounting housing is rotatably connected to a rotating shaft which is connected to a rotary drive mechanism, the rotating shaft is drivingly connected to first and second sliding elements, which are jointly connected to a scissor linkage mechanism, the scissor linkage mechanism is connected to a base, the rotary drive mechanism drives the first and second sliding elements to move in opposite directions via the rotating shaft, thereby driving the base to move vertically away from or towards the fork via the scissor linkage mechanism; and a rolling element is rotatably connected to a bottom end of the base. A grid-shaped pallet handling robot includes the AMR-based adaptive forking mechanical structure.

### CROSS-REFERENCE TO RELATED APPLICATIONS

This application is a continuation of PCT application serial no. PCT/CN2025/112591, filed on Aug. 5, 2025, which claims the priority and benefit of Chinese patent application serial no. 202510549529.7, filed on Apr. 29, 2025. The entireties of PCT application serial no. PCT/CN2025/112591 and Chinese patent application serial no. 202510549529.7 are hereby incorporated by reference herein and made a part of this specification.

### TECHNICAL FIELD

The present application relates to the technical field of handling robots, and more particularly, to an AMR-based adaptive forking mechanical structure and a grid-shaped pallet handling robot.

### BACKGROUND ART

In a field of modern logistics and warehousing, with a continuous improvement of automation and intelligence, an autonomous mobile robot (AMR) has gradually become a key equipment for realizing logistics handling automation by virtue of its high flexibility and convenient deployment, a grid-shaped pallet is a unit container widely used in logistics transportation, warehousing management, and other links. Its structural feature is that forking openings at the bottom are distributed in a grid shape, providing stable load-bearing and stacking functions for goods.

At present, an autonomous mobile robot generally includes at least a vehicle body, a drive unit capable of moving the vehicle body, and a forking mechanical structure capable of forking the grid-shaped pallet and placing it on the vehicle body. Specifically, the forking mechanical structure includes a fork rod, the fork rod can be inserted into the forking opening of the grid-shaped pallet and lift the grid-shaped pallet to move it, the fork rod has functions of reciprocating translation and lifting.

For the above-related solutions, the inventors believe that there are the following defects: in terms of handling stability, if the goods carried by the grid-shaped pallet are heavy and a center of gravity deviates from a central position of the grid-shaped pallet, the grid-shaped pallet may shake or even overturn during a process of being forked and moved by fork rods, leading to failure in handling the goods.

### SUMMARY

To stably handle the goods, the present application provides an AMR-based adaptive forking mechanical structure and a grid-shaped pallet handling robot.

An AMR-based adaptive forking mechanical structure provided by the present application includes a plate body, wherein the plate body is mounted with a translation device, the translation device is mounted with a fork, and the fork is mounted with a lifting device;

the translation device includes a slow-speed translation mechanism mounted on the plate body, the slow-speed translation mechanism is vertically and slidably connected to a frame body, the frame body is connected to a rapid translation mechanism, the rapid translation mechanism is connected to an angle adjustment mechanism, and the fork is connected to the angle adjustment mechanism;

the lifting device includes a mounting housing mounted on the fork, the mounting housing is rotatably connected to a rotating shaft, the rotating shaft is connected to a rotary drive mechanism, the rotating shaft is also drivingly connected to a first sliding element and a second sliding element, the first sliding element and the second sliding element are jointly connected to a scissor linkage mechanism, the scissor linkage mechanism is connected to a base for abutting against the ground, the rotary drive mechanism drives the first sliding element and the second sliding element to move in opposite directions via the rotating shaft, thereby driving the base to move vertically away from or towards the fork via the scissor linkage mechanism, and a rolling element is rotatably connected to a bottom end of the base.

By adopting the above technical solution, in the present application, the goods are handled as follows: after the autonomous mobile robot moves to a side of the goods, the slow-speed translation mechanism is used to drive the fork to be inserted into a forking opening of the grid-shaped pallet. Then, the rotary drive mechanism is driven to rotate the rotating shaft, thereby driving the first sliding element and the second sliding element to move in opposite directions. At this time, under an action of the scissor linkage mechanism, the base will move vertically away from the fork and abut against the ground to lift the goods. Subsequently, the slow-speed translation mechanism is driven to move and reset the fork, thereby moving the goods towards the autonomous mobile robot. During the movement of the goods, the rolling element rolls to facilitate the movement, the goods reach above the autonomous mobile robot, and then the rotary drive mechanism is driven again to reset the base, placing the goods on the autonomous mobile robot. In the above-mentioned aspect, since the movement of the goods is supported by the scissor linkage mechanism and the base, the movement of the goods is stable.

Optionally, the scissor linkage mechanism includes a first linkage arm connected to the first sliding element and a second linkage arm connected to the second sliding element, the first linkage arm and the second linkage arm are arranged crosswise and hingedly connected at a crossing point, a lower end of the first linkage arm is further hingedly connected to a third linkage arm, and a lower end of the second linkage arm is further hingedly connected to a fourth linkage arm, a lower end of the third linkage arm and a lower end of the fourth linkage arm are hingedly connected to the base.

By adopting the above technical solution, when the rotary drive mechanism drives the first sliding element and the second sliding element to move in opposite directions, under an action of the first linkage arm, the second linkage arm, the third linkage arm and the fourth linkage arm, the base will move in a direction away from or close to the fork.

Optionally, the first sliding element includes a sliding sleeve threadedly connected to the rotating shaft, a sliding post is connected to the sliding sleeve, and the mounting housing is provided with a sliding slot in which the sliding post is slidably connected.

Optionally, the rapid translation mechanism includes a first tube body connected to the frame body, a second tube body is slidably connected to an inner wall of the first tube body, a third tube body is slidably connected to an inner wall of the second tube body, a rotating gear is rotatably connected to the second tube body, a first rack is fixedly connected to the first tube body, and the first rack is engaged with the rotating gear; a second rack is fixedly connected to the third tube body, and the second rack is engaged with the rotating gear; the first rack and the second rack are respectively located at two sides of the rotating gear, and the rotating gear is connected with a rotary drive component; and the angle adjustment mechanism is connected to the third tube body.

By adopting the above technical solution, the rotary drive component is driven to rotate the rotating gear, so that the rotating gear moves with respect to the first rack and the second rack moves with respect to the rotating gear, that is, the second tube body moves with respect to the first tube body while the third tube body moves with respect to the second tube body, and the multi-stage structure causes the fork to be rapidly moved. In addition, the multi-stage structure allows for the fork to be extended further to meet different forking requirements.

Optionally, the first tube body includes a containing tube section and a mounting tube section, and the mounting tube section is connected to an end of the containing tube section facing the fork; the second tube body includes a complete tube section and an incomplete tube section, and the complete tube section is connected to and end of the incomplete tube section facing the fork; with respect to the first tube body, the third tube body has a first extreme position and a second extreme position, the second extreme position is located on a side of the first extreme position away from the plate body, and when the third tube body is located at the first extreme position, the second rack and the incomplete tube section are both located in the containing tube section.

Optionally, the incomplete tube section has a limit post, the first tube body is provided with a limit slot, the limit post is slidably connected to the limit slot, and the limit slot is capable of limiting a movement stroke of the limit post and thus limiting the movement stroke of the second tube body.

By adopting the above technical solution, a sliding engagement of the limit slot with the limit post enables the movement of the second tube body to be guided and the movement stroke to be limited.

Optionally, the angle adjustment mechanism includes a first mounting tube connected to the rapid translation mechanism, the first mounting tube is mounted with a reciprocating driving assembly, an outer wall of the first mounting tube is slidably connected to an arc-shaped plate, the arc-shaped plate is connected to the reciprocating driving assembly, the first mounting tube is rotatably connected to a second mounting tube, an inner wall of the second mounting tube is provided with a sliding head, an outer wall of the arc-shaped plate is provided with a spiral slot in which the sliding head is slidably connected, and the fork is connected to the second mounting tube.

By adopting the above technical solution, the reciprocating driving assembly can be driven to drive the arc-shaped plate to slide on the outer wall of the first mounting tube, and at this time, under an action of a sliding fit between the sliding head and the spiral slot, the second mounting tube will rotate with respect to the first mounting tube, and on this basis, the fork can be made to rotate.

Optionally, the rolling element is a roller wheel.

Optionally, an end of the fork away from the plate body has a tapered portion.

By adopting the above technical solution, the tapered portion can be easily inserted into the forking opening of the grid-shaped pallet.

The present application also discloses a grid-shaped pallet handling robot: the AMR-based adaptive forking mechanical structure is included.

In summary, the present application includes at least one of the following beneficial technical effects:
1. In the present application, the goods are handled as follows: after the autonomous mobile robot moves to the side of the goods, the slow-speed translation mechanism is used to drive the fork to be inserted into the forking opening of the grid-shaped pallet. Then, the rotary drive mechanism is driven to rotate the rotating shaft, thereby driving the first sliding element and the second sliding element to move in opposite directions. At this time, under the action of the scissor linkage mechanism, the base will move vertically away from the fork and abut against the ground to lift the goods. Subsequently, the slow-speed translation mechanism is driven to move and reset the fork, thereby moving the goods towards the autonomous mobile robot. During the movement of the goods, the rolling element rolls to facilitate the movement, the goods reach above the autonomous mobile robot, and then the rotary drive mechanism is driven again to reset the base, placing the goods on the autonomous mobile robot. In the above-mentioned aspect, since the movement of the goods is supported by the scissor linkage mechanism and the base, the movement of the goods is stable;
2. The present application can drive the fork to translate rapidly and can enable the fork to extend further, and the present application can also drive the fork to rotate. The fork is quickly moved as follows: the rotation-providing assembly is driven to drive the rotating gear to rotate, so that the rotating gear moves with respect to the first rack and the second rack moves with respect to the rotating gear, that is, the second tube body moves with respect to the first tube body while the third tube body moves with respect to the second tube body, and the fork will move quickly along with the third tube body; the fork is rotated as follows: the reciprocating driving assembly drives the arc-shaped plate to slide on the outer wall of the first mounting tube, and at this time, under the action of the sliding fit between the sliding head and the spiral slot, the second mounting tube will rotate with respect to the first mounting tube, and the fork will rotate along with the second mounting tube.

### BRIEF DESCRIPTION OF THE DRAWINGS

FIG. 1 is a schematic structure view of a grid-shaped pallet;

FIG. 2 is a schematic structure view of an AMR-based adaptive forking mechanical structure according to an embodiment of the present application;

FIG. 3 is a cross-sectional view for showing a translation device;

FIG. 4 is an enlarged view of portion A in FIG. 2;

FIG. 5 is an enlarged view of portion B in FIG. 3;

FIG. 6 is an exploded view for showing a first tube body, a second tube body, and a third tube body;

FIG. 7 is a cross-sectional view for showing an angle adjustment mechanism;

FIG. 8 is a schematic structure view for showing an arc-shaped plate;

FIG. 9 is a cross-sectional view for showing a second mounting tube;

FIG. 10 is a schematic structure view for showing a lifting device;

FIG. 11 is a schematic structure view for showing a scissor linkage mechanism; and

FIG. 12 is a schematic structure view for showing a robot body.

### DETAILED DESCRIPTION

The present application will be further described in detail below with reference to the accompanying drawings.

In the description of the present application, it should be understood that directional descriptions, such as upper, lower, front, rear, left, right, etc., indicating orientations or positional relationships are based on the orientations or positional relationships shown in the accompanying drawings, these are only for the convenience of describing the present application and simplifying the description, and do not indicate or imply that the referred device or element must have a specific orientation, be constructed and operated in a specific orientation. Therefore, they should not be construed as limiting the present application.

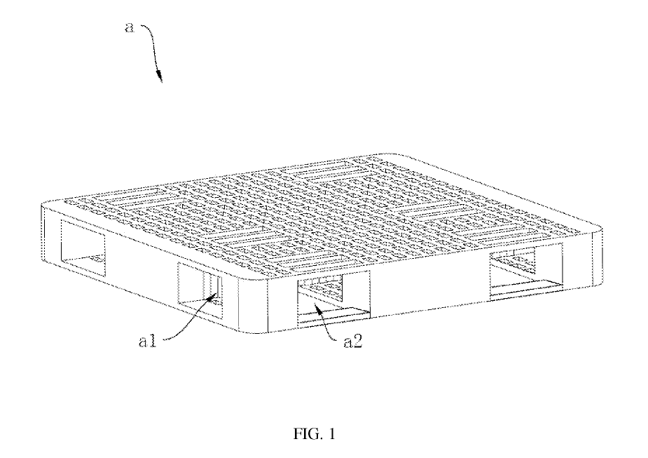

The embodiments of the present application disclose an AMR-based adaptive forking mechanical structure for stably handling goods. Referring to FIG. 1, specifically, the present application performs goods handling based on the handling of a grid-shaped pallet a, wherein the grid-shaped pallet a includes two forking openings a1 that penetrate transversely and a slot body a2 at a bottom end, and the slot body a2 extends upward to communicated with the forking openings a1.

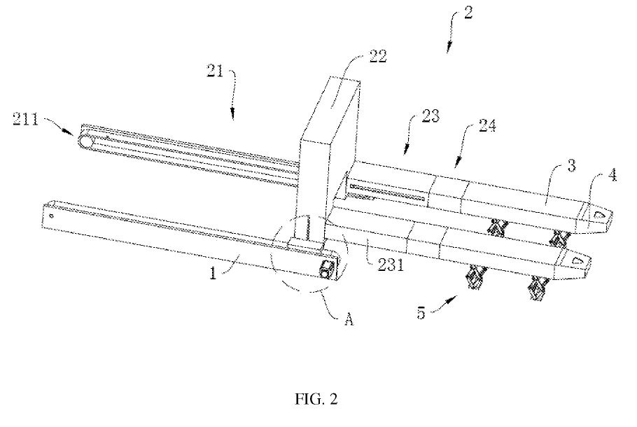

Referring to FIGS. 1 and 2, an AMR-based adaptive forking mechanical structure includes a plate body 1 mounted on an autonomous mobile robot, the plate body 1 is mounted with a translation device 2, the translation device 2 is mounted with a fork 3, a tapered portion 4 is provided at a right end of the fork 3, and the fork 3 is mounted with a lifting device 5.

After installing the AMR-based adaptive forking mechanical structure on the autonomous mobile robot, the autonomous mobile robot is first driven to move to a side of the grid-shaped pallet a, i.e., a goods side. Then, a translation mechanism is used to drive the fork 3 to translate and insert into the forking opening a1, the lifting device 5 is used to raise the grid-shaped pallet a. Afterward, the translation mechanism is driven to return the fork 3 to its original position, thereby bringing the grid-shaped pallet a, i.e., the goods, above the autonomous mobile robot. Finally, the lifting device 5 is driven again to lower the grid-shaped pallet and placed on the autonomous mobile robot.

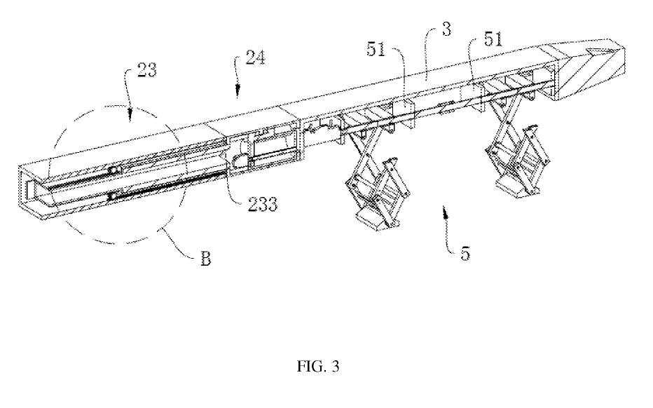

Referring to FIGS. 2 and 3, the translation device 2 includes a slow-speed translation mechanism 21 mounted on the plate body 1, the slow-speed translation mechanism 21 is vertically and slidably connected to a frame body 22, the frame body 22 is connected to a rapid translation mechanism 23 which is connected to an angle adjustment mechanism 24, and the fork 3 is connected to the angle adjustment mechanism 24.

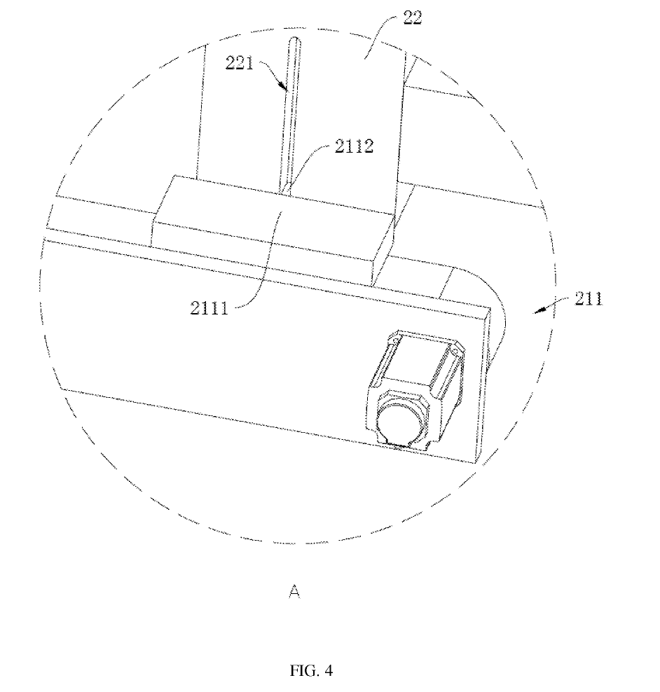

Referring to FIGS. 2 and 4, the slow-speed translation mechanism 21 is optionally a synchronous belt transmission mechanism 211 in the present embodiment, a specific structure of the synchronous belt transmission mechanism 211 is prior art and will not be repeated herein. The frame body 22 is slidably connected to the synchronous belt transmission mechanism 211. Specifically, the synchronous belt transmission mechanism 211 includes a block 2111 connected to the synchronous belt, a post body 2112 is connected to the block 2111, the frame body 22 has a guiding slot 221 arranged vertically, the post body 2112 is slidably connected to the guiding slot 2411. Under normal conditions, i.e., when the lifting device 5 is not driven, the post body 2112 abuts against an upper notch of the guiding slot 2411 due to gravity. When the lifting device 5 is driven to lift the fork 3, the frame body 22 moves upward simultaneously. FIG. 4 is a schematic structural view of the fork 3 after being lifted.

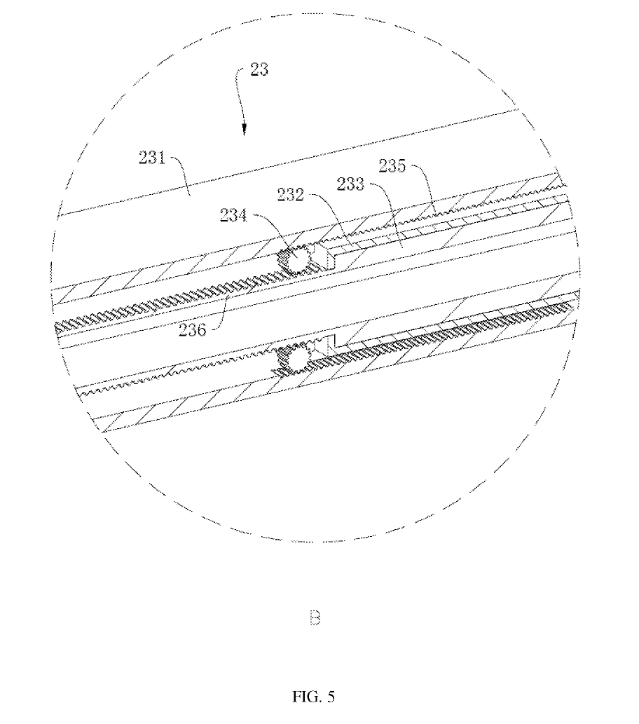

Referring to FIGS. 2 and 5, the rapid translation mechanism 23 includes a first tube body 231 connected to the frame body 22, a second tube body 232 is slidably connected to an inner wall of the first tube body 231, a third tube body 233 is slidably connected to an inner wall of the second tube body 232, the first tube body 231, the second tube body 232, and the third tube body 233 are all square tube bodies; a rotating gear 234 is rotatably connected to the second tube body 232, a first rack 235 is fixedly connected to the first tube body 231 and the first rack 235 is engaged with the rotating gear 234, the first rack 235 is arranged transversely, a second rack 236 is fixedly connected to the third tube body 233 and the second rack 236 is engaged with the rotating gear 234, the second rack 236 is also arranged transversely. The first rack 235 and the second rack 236 are located on upper and lower sides of the rotating gear 234, respectively. The rotating gear 234 is connected to a rotary drive component, optionally a motor; the angle adjustment mechanism 24 is connected to the third tube body 233.

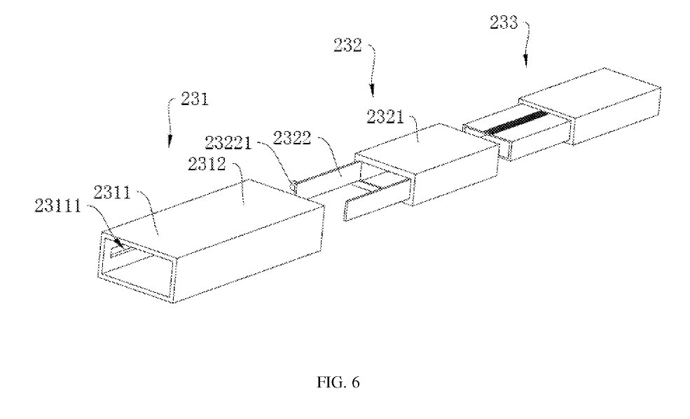

Referring to FIGS. 5 and 6, specifically, the first tube body 231 includes a containing tube section 2311 and a mounting tube section 2312, the mounting tube section 2312 is connected to a right end of the containing tube section 2311. The second tube body 232 includes a complete tube section 2321 and an incomplete tube section 2322, the complete tube section 2321 is connected to a right end of the incomplete tube section 2322; with respect to the first tube body 231, the third tube body 233 has a first extreme position and a second extreme position, the second extreme position is located to the right of the first extreme position, and when the third tube body 233 is located in the first extreme position, the second rack 236 and the incomplete tube section 2322 are both located in the containing tube section 2311, and at this time, a right end of the third tube body 233 slightly protrudes from the first tube body 231. FIG. 5 shows a schematic view of the third tube body 233 in the first extreme position.

Referring to FIG. 6, in order to prevent the second tube body 232 from moving over and guiding a movement of the second tube body 232, the incomplete tube section 2322 has a limit post 23221, the first tube body 231 is provided with a limit slot 23111, the limit slot 23111 is arranged transversely, the limit post 23221 is slidably connected to the limit slot 23111, and the limit slot 23111 can limit a movement stroke of the limit post 23221 and thus limit the movement stroke of the second tube body 232.

The rotary drive component is driven to drive the rotating gear 234 to rotate, so that the rotating gear 234 moves with respect to the first rack 235 and the second rack 236 moves with respect to the rotating gear 234, that is, the second tube body 232 moves with respect to the first tube body 231 while the third tube body 233 moves with respect to the second tube body 232, and the third tube body 233 moves to drive the angle adjustment mechanism 24 to move, and thus drive the fork 3 to move.

The above-mentioned multi-stage structure is used to enable the fork 3 to be moved quickly and the fork 3 to be extended further. Generally, the rapid translation mechanism 23 will not be driven, and only when the autonomous mobile robot cannot move to a position close to the grid-shaped pallet a will a need to handle the grid-shaped pallet a, i.e., the goods, further be satisfied by controlling the simultaneous activation of the slow-speed translation mechanism 21 and the rapid translation mechanism 23.

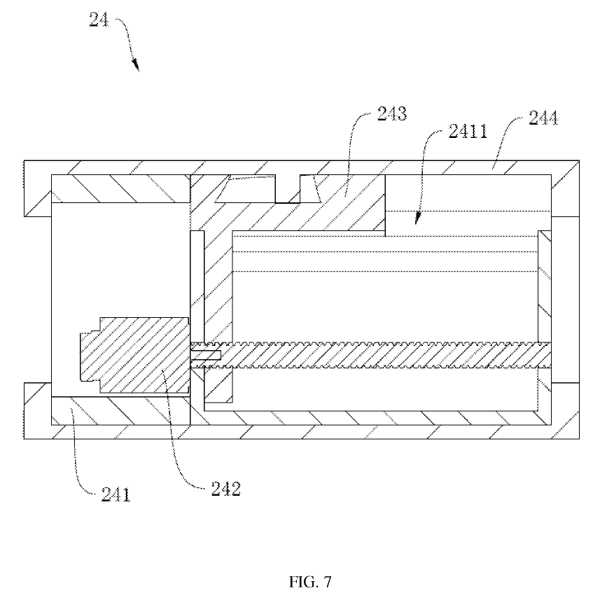

Referring to FIGS. 6 and 7, the angle adjustment mechanism 24 includes a first mounting tube 241 connected to the third tube body 233, the first mounting tube 241 is mounted with a reciprocating driving assembly 242, an outer wall of the first mounting tube 241 is slidably connected with an arc-shaped plate 243, the reciprocating driving assembly 242 is connected with the arc-shaped plate 243, and specifically, the reciprocating driving assembly 242 is a screw rod transmission mechanism, and the arc-shaped plate 243 is connected with an output end of the screw rod transmission mechanism; the first mounting tube 241 includes a guiding slot 2411 provided in a transversal direction of an outer wall thereof, and the arc-shaped plate 243 is slidably connected to the guiding slot 2411. The arc-shaped plate 243 is moved right and left along the guiding slot 2411 by driving the reciprocating driving assembly 242.

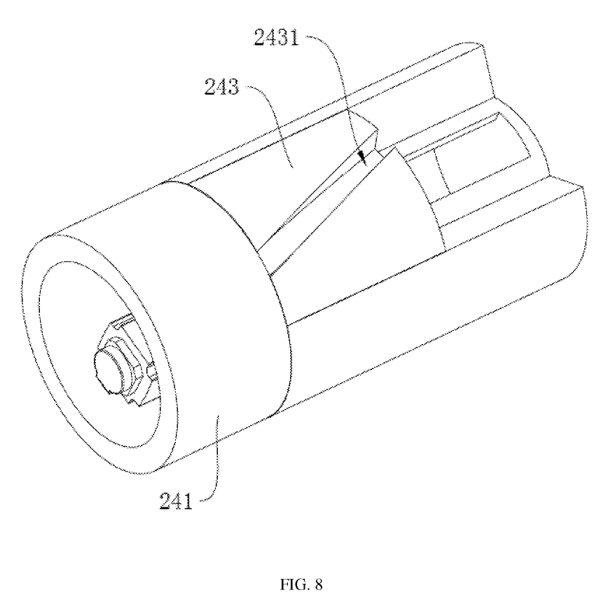

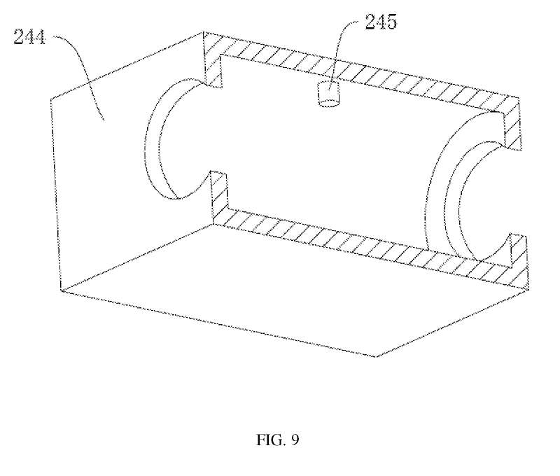

Referring to FIGS. 7, 8 and 9, a second mounting tube 244 is rotatably connected to the first mounting tube 241, the second mounting tube 244 is square-shaped outside and circular inside, a sliding head 245 is provided on an inner wall of the second mounting tube 244, a spiral slot 2431 is provided on an outer wall of the arc-shaped plate 243, and the sliding head 245 is slidably connected to the spiral slot 2431; the fork 3 is fixedly connected to the second mounting tube 244. With the sliding head 245 engaged with the spiral slot 2431, a movement of the arc-shaped plate 243 to the left and right drives the second mounting tube 244 to rotate with respect to the first mounting tube 241.

The reciprocating driving assembly 242 is driven to move the arc-shaped plate 243 to the left and right so as to rotate the second mounting tube 244 in forward and reverse directions with respect to the first mounting tube 241.

When the grid-shaped pallet a is misplaced, the forking opening a1 may be inclined to the ground, and in this regard, the second mounting tube 244 can be rotated by using the above-mentioned structure so that the fork 3 can be rotated to ensure that the fork 3 can be subsequently inserted into the forking opening a1. Of course, when handling the grid-shaped pallet a, in order to ensure that the goods do not overturn, after the fork 3 is rotatably inserted into the forking opening a1, when lifting the fork 3, the fork 3 is simultaneously driven to rotate and reset so as to ensure that the moved grid-shaped pallet a remains in a horizontal state.

It should be noted that if a speed at which the arc-shaped plate 243 moves left and right is constant, a size of an spiral angle of the spiral slot 2431 is related to a rotational speed and rotational accuracy of the fork 3, the smaller the spiral angle is and the longer the spiral slot 2431 is, the slower the rotational speed of the fork 3 will be, but the higher the accuracy will be.

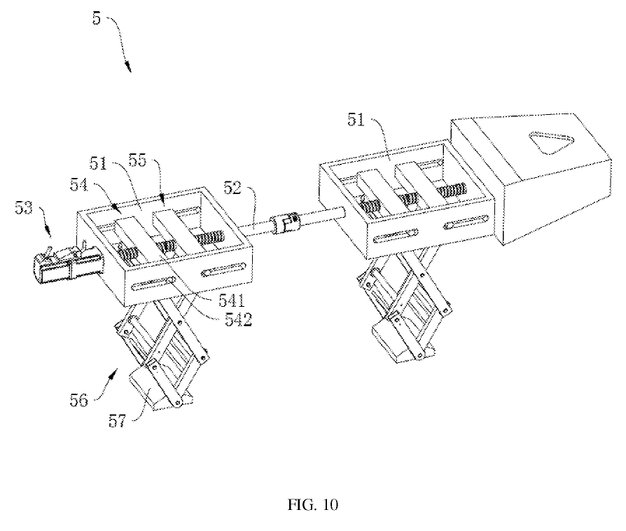

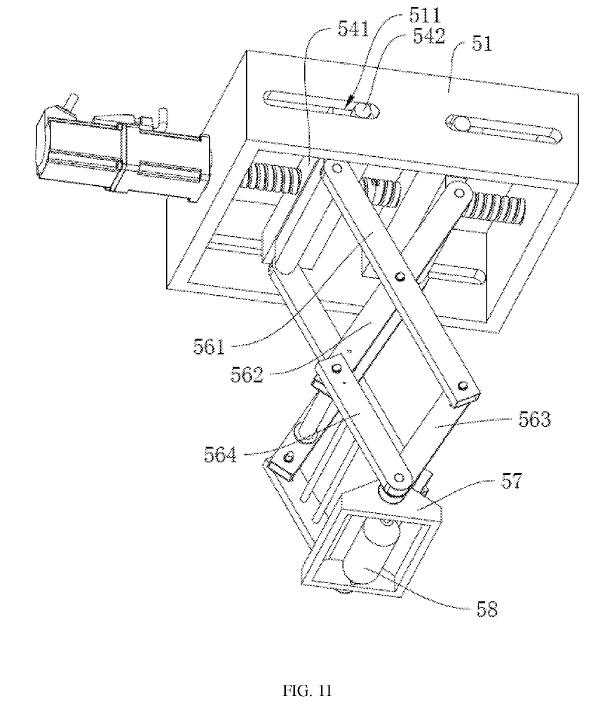

Referring to FIG. 10, the lifting device 5 includes two mounting housings 51. In conjunction with FIG. 2, the two mounting housings 51 are transversely arranged and mounted on the fork 3, the fork 3 is hollow and has an opening facing downwards. The two mounting housings 51 are jointly rotatably connected to a rotating shaft 52, the rotating shaft 52 is connected to a rotary drive mechanism 53, which is optionally a speed-reducing motor. The rotary drive mechanism 53 can drive the rotating shaft 52 to rotate. The rotating shaft 52 corresponds to one of the two mounting housings 51, each mounting housing 51 is drivingly connected to a first sliding element 54 and a second sliding element 55. The first sliding element 54 and the second sliding element 55 are jointly connected to a scissor linkage mechanism 56, the scissor linkage mechanism 56 is connected to a base 57 for abutting against the ground. The rotary drive mechanism 53 is used for driving the first sliding element 54 and the second sliding element 55 to move in opposite directions via the rotating shaft 52 so as to drive the base 57 away from or close to the fork 3 in a vertical direction via the scissor linkage mechanism 56. Referring to FIG. 11, a rolling element 58, which is optionally a roller wheel, is rotatably connected to a bottom end of the base 57.

Referring to FIG. 11, specifically, a structure of the first sliding element 54 is the same as that of the second sliding element 55. Taking the structure of the first sliding element 54 as an example: the first sliding element 54 includes a sliding sleeve 541, which is in threaded connection with the rotating shaft 52; a sliding post 542 is connected to the sliding sleeve 541, a sliding slot 511 is defined on each mounting housing 51, the sliding slot 511 is arranged transversely, and the sliding post 542 is slidably connected to the sliding slot 511.

Referring to FIG. 11, the scissor linkage mechanism 56 includes a first linkage arm 561 connected to the first sliding element 54 and a second linkage arm 562 connected to the second sliding element 55, the first linkage arm 561 and the second linkage arm 562 are arranged crosswise and hingedly connected at a crossing point; a lower end of the first linkage arm 561 is further hingedly connected to a third linkage arm 563, and a lower end of the second linkage arm 562 is further hingedly connected to a fourth linkage arm 564, a lower end of the third linkage arm 563 and a lower end of the fourth linkage arm 564 are hingedly connected to the base 57.

After the fork 3 is inserted into the forking opening a1 of the grid-shaped pallet a, the rotary drive mechanism 53 is driven to rotate the rotating shaft 52, thereby driving the first sliding element 54 and the second sliding element 55 to move in opposite directions, at this time, under an action of the scissor linkage mechanism 56, the base 57 will move downwards away from the fork 3 and abut against the ground to lift the goods. Subsequently, the translation device 2 is driven to move and reset the fork 3, thereby moving the goods towards the autonomous mobile robot. During the movement of the goods, the rolling element 58 rolls to facilitate the movement, the goods reach above the autonomous mobile robot, and then the rotary drive mechanism 53 is driven again to reset the base 57, placing the goods on the autonomous mobile robot.

The implementation principle of the AMR-based adaptive forking mechanical structure in the embodiment of the present application is as follows:

After the AMR-based adaptive forking mechanical structure is mounted on the autonomous mobile robot, the autonomous mobile robot is first driven to move to the side of the grid-shaped pallet a. Then, the synchronous belt transmission mechanism 211 is driven to translate the fork 3 in a direction away from the autonomous mobile robot and insert it into the forking opening a1. Subsequently, the rotary drive mechanism 53 is driven to rotate the rotating shaft 52, thereby driving the first sliding element 54 and the second sliding element 55 to move in opposite directions. At this time, under an action of the first linkage arm 561, the second linkage arm 562, the third linkage arm 563, and the fourth linkage arm 564, the base 57 will move downwards away from the fork 3. At this time, the base 57 will abut against the ground, causing the fork 3 to move upwards and lift the grid-shaped pallet a, i.e., the goods. As the fork 3 moves upwards, the post body 2112 will slide upwards in the guiding slot 221. Then, the synchronous belt transmission mechanism 211 is driven to move and reset the fork 3, thereby moving the goods towards the autonomous mobile robot. During the movement of the goods, the rolling element 58 rolls to facilitate the movement, the goods reach above the autonomous mobile robot, and then the rotary drive mechanism 53 is driven again to reset the base 57, placing the goods on the autonomous mobile robot.

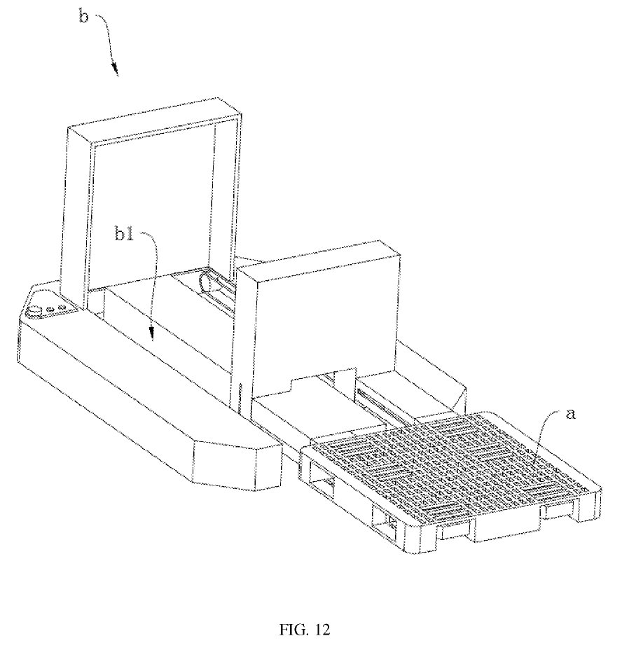

The present application also discloses a grid-shaped pallet handling robot. Referring to FIG. 12, it includes a robot body b and an AMR-based adaptive forking mechanical structure mounted on the robot body b. Wherein, the robot body b is formed with two accommodation areas b1 for accommodating the AMR-based adaptive forking mechanical structure. In addition, to stably handle the grid-shaped pallet a, i.e., the goods, two AMR-based adaptive forking mechanical structures are provided.

The embodiments in this specific implementation mode are all preferred embodiments of the present application, and are not intended to limit the protection scope of the present application. Therefore, all equivalent changes made according to the structure, shape and principle of the present application should be covered within the protection scope of the present application.

### LIST OF REFERENCE SIGNS

a. grid-shaped pallet;
a1. forking opening;
a2. slot body;
b. robot body;
b1. accommodation area;
1. plate body;
2. translation device;
21. slow-speed translation mechanism;
211. synchronous belt transmission mechanism;
2111. block;
2112. post body;
22. frame body;
221. guiding slot;
23. rapid translation mechanism;
231. first tube body;
2311. containing tube section;
23111. limit slot;
2312. mounting tube section;
232. second tube body;
2321. complete tube section;
2322. incomplete tube section;
23221. limit post;
233. third tube body;
234. rotating gear;
235. first rack;
236. second rack;
24. angle adjustment mechanism;
241. first mounting tube;
2411. guiding slot;
242. reciprocating driving assembly;
243. arc-shaped plate;
2431. spiral slot;
244. second mounting tube;
245. sliding head;
3. fork;
4. tapered portion;
5. lifting device;
51. mounting housing;
511. sliding slot;
52. rotating shaft;
53. rotary drive mechanism;
54. first sliding element;
541. sliding sleeve;
542. sliding post;
55. second sliding element;
56. scissor linkage mechanism;
561. first linkage arm;
562. second linkage arm;
563. third linkage arm;
564. fourth linkage arm;
57. base;
58. rolling element.

What is claimed is:

1. An autonomous mobile robot based (AMR-based) adaptive forking mechanical structure, comprising a plate body, wherein the plate body is mounted with a translation device, the translation device is mounted with a fork, and the fork is mounted with a lifting device;
the translation device comprises a slow-speed translation mechanism mounted on the plate body, the slow-speed translation mechanism is vertically and slidably connected with a frame body, the frame body is connected with a rapid translation mechanism, the rapid translation mechanism is connected with an angle adjustment mechanism, and the fork is connected to the angle adjustment mechanism;
the lifting device comprises a mounting housing mounted on the fork, the mounting housing is rotatably connected with a rotating shaft, the rotating shaft is connected with a rotary drive mechanism, the rotating shaft is further drivingly connected to a first sliding element and a second sliding element, the first sliding element and the second sliding element are jointly connected to a scissor linkage mechanism, the scissor linkage mechanism is connected to a base for abutting against ground, the rotary drive mechanism is configured to drive the first sliding element and the second sliding element to move in opposite directions via the rotating shaft, thereby driving the base to move vertically away from or towards the fork via the scissor linkage mechanism, and a rolling element is rotatably connected to a bottom end of the base; and
the angle adjustment mechanism comprises a first mounting tube connected to the rapid translation mechanism, the first mounting tube is mounted with a reciprocating driving assembly, an outer wall of the first mounting tube is slidably connected to an arc-shaped plate, the arc-shaped plate is connected to the reciprocating driving assembly, the first mounting tube is rotatably connected to a second mounting tube, an inner wall of the second mounting tube is provided with a sliding head, an outer wall of the arc-shaped plate is provided with a spiral slot, the sliding head is slidably arranged in the spiral slot, and the fork is connected to the second mounting tube.

2. The AMR-based adaptive forking mechanical structure according to claim 1, wherein the scissor linkage mechanism comprises a first linkage arm connected to the first sliding element and a second linkage arm connected to the second sliding element, the first linkage arm and the second linkage arm are arranged crosswise and hingedly connected at a crossing point, a lower end of the first linkage arm is further hingedly connected to a third linkage arm, a lower end of the second linkage arm is further hingedly connected to a fourth linkage arm, and a lower end of the third linkage arm and a lower end of the fourth linkage arm are hingedly connected to the base.

3. The AMR-based adaptive forking mechanical structure according to claim 1, wherein the first sliding element comprises a sliding sleeve threadedly connected to the rotating shaft, a sliding post is connected to the sliding sleeve, the mounting housing is provided with a sliding slot, and the sliding post is slidably arranged in the sliding slot.

4. The AMR-based adaptive forking mechanical structure according to claim 1, wherein the rapid translation mechanism comprises a first tube body connected to the frame body, a second tube body is slidably connected to an inner wall of the first tube body, a third tube body is slidably connected to an inner wall of the second tube body, a rotating gear is rotatably connected to the second tube body, a first rack is fixedly connected to the first tube body, the first rack is engaged with the rotating gear, a second rack is fixedly connected to the third tube body, the second rack is engaged with the rotating gear, the first rack and the second rack are respectively located at two sides of the rotating gear, the rotating gear is connected with a rotary drive component, and the angle adjustment mechanism is connected to the third tube body.

5. The AMR-based adaptive forking mechanical structure according to claim 4, wherein the first tube body comprises a containing tube section and a mounting tube section, the mounting tube section is connected to an end of the containing tube section facing the fork, the second tube body comprises a complete tube section and an incomplete tube section, the complete tube section is connected to an end of the incomplete tube section facing the fork, with respect to the first tube body, the third tube body has a first extreme position and a second extreme position, the second extreme position is located on a side of the first extreme position away from the plate body, and when the third tube body is located at the first extreme position, the second rack and the incomplete tube section are both located in the containing tube section.

6. The AMR-based adaptive forking mechanical structure according to claim 5, wherein the incomplete tube section has a limit post, the first tube body is provided with a limit slot, the limit post is slidably connected to the limit slot, and the limit slot is configured to limit a movement stroke of the limit post and thus limiting a movement stroke of the second tube body.

7. The AMR-based adaptive forking mechanical structure according to claim 1, wherein the rolling element is a roller wheel.

8. The AMR-based adaptive forking mechanical structure according to claim 1, wherein an end of the fork away from the plate body has a tapered portion.

9. A grid-shaped pallet handling robot, comprising the AMR-based adaptive forking mechanical structure according to claim 1.
